(19) United States
(12) Patent Application Publication
(10) Pub. No.: US 2022/0253845 A1
(43) Pub. Date: Aug. 11, 2022

(54) SYSTEM AND METHODS FOR REMOTELY GENERATING, AUTHENTICATING, AND VALIDATING DUAL VALIDATION DATA OBJECTS

(71) Applicant: Assurant, Inc., New York, NY (US)

(72) Inventors: Nathan Werner, Mukwonago, WI (US); Michael Garza, Kettering, OH (US)

(21) Appl. No.: 17/172,784

(22) Filed: Feb. 10, 2021

(51) Int. Cl. G06Q 20/40; H04L 9/32

(52) U.S. Cl. CPC G06Q 20/401; H04L 9/32

(57) ABSTRACT

Various embodiments of the present disclosure are directed to a dual validation authentication system that is configured to more efficiently manage the processing of dual validation data objects. In particular, in some embodiments, the dual validation authentication system is configured to authorize loss authentication data objects received from client devices. In other embodiments, the dual validation authentication system is configured to provide secondary validation of dual validation data objects and generate dual validation work objects to initiate an electronic fund disbursement.

### TECHNOLOGICAL FIELD

Various embodiments relate generally to a dual validation authentication system that is configured to more efficiently manage the creation, transmission, and processing of dual validation data objects.

### BACKGROUND

Existing mobile deposit authentication systems exhibit disadvantages, particularly in instances in which multiple external systems are involved in authentication and validation operations. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

One embodiment is directed to a dual validation authentication system that includes one or more computers and one or more storage devices storing instructions that are operable, when executed by the one or more computers, to cause the dual validation authentication system to receive a loss authentication data object from a client device, the loss authentication data object comprising loss authentication parameters. The instructions are further operable, when executed by the one or more computers, to cause the dual validation authentication system to compare the loss authentication parameters to remote dual validation authorization criteria. The instructions are further operable, when executed by the one or more computers, to cause the dual validation authentication system to, in a circumstance where the loss authentication parameters are determined to satisfy the remote dual validation authorization criteria, output a dual validation authorization approval instruction. The instructions are further operable, when executed by the one or more computers, to cause the dual validation authentication system to receive a dual validation data object from the client device, the dual validation data object comprising requester validation data and a requester validation image.

The instructions are further operable, when executed by the one or more computers, to cause the dual validation authentication system to determine whether data extracted from the dual validation data object satisfies a predefined threshold. The instructions are further operable, when executed by the one or more computers, to cause the dual validation authentication system to in accordance with determining that the data extracted from the dual validation data object satisfies the predefined threshold, access secondary validation data and a secondary validation image. The instructions are further operable, when executed by the one or more computers, to cause the dual validation authentication system to generate a first dual validation work object based at least on the dual validation data object, the secondary validation data, and the secondary validation image. The instructions are further operable, when executed by the one or more computers, to cause the dual validation authentication system to generate a set of dual validation work objects including the first dual validation work object. The instructions are further operable, when executed by the one or more computers, to cause the dual validation authentication system to cause transmission of the set of dual validation work objects to initiate an electronic fund disbursement to an account associated with the client device.

In some embodiments, the loss authentication parameters comprise one or more of a client identifier, a loan identifier, a loss date identifier, a loss amount identifier, and a loss cause identifier.

In some embodiments, the instructions that are operable, when executed by the one or more computers, to cause the dual validation authentication system to compare the loss authentication parameters to the remote dual validation authorization criteria are further operable to cause the dual validation authentication system to determine whether the loss amount identifier exceeds a predefined loss amount threshold, the loss authentication parameters being determined to satisfy the remote dual validation authorization criteria in a circumstance where the loss amount identifier does not exceed the predefined loss amount threshold.

In some embodiments, the instructions are further operable, when executed by the one or more computers, to cause the dual validation authentication system to initiate a remote dual validation client interface to be rendered at the client device, the remote dual validation client interface configured to capture at least the requester validation image. In some embodiments, the instructions are further operable, when executed by the one or more computers, to cause the dual validation authentication system to, upon receiving the dual validation data object, extract textual data from the requester validation image of the dual validation data object.

In some embodiments, the instructions are further operable, when executed by the one or more computers, to cause the dual validation authentication system to, in accordance with determining that the data extracted from the dual validation data object fails to satisfy the predefined threshold, cause transmission of a notification to the client device, the notification comprising instructions for resubmission of the dual validation data object.

In some embodiments, the instructions that are operable, when executed by the one or more computers, to cause the dual validation authentication system to access the secondary validation data and the secondary validation image are further operable to cause the dual validation authentication system to access an encrypted validation object comprising the secondary validation data and the secondary validation image. In some embodiments, the instructions are further operable, when executed by the one or more computers, to cause the dual validation authentication system to access a decryption key for the encrypted validation object. In some embodiments, the instructions are further operable, when executed by the one or more computers, to cause the dual validation authentication system to decrypt the encrypted validation object.

In some embodiments, the instructions are further operable, when executed by the one or more computers, to cause the dual validation authentication system to, in the circumstance where the loss authentication parameters are determined to satisfy the remote dual validation authorization criteria generate a tracking identifier for the loss authentication data object. In some embodiments, the instructions are further operable, when executed by the one or more computers, to cause the dual validation authentication system to initiate a loss tracking client interface to be rendered at the client device, the loss tracking client interface comprising an indication of the tracking identifier and configured to provide status updates associated with the loss authentication data object to a user of the client device.

In some embodiments, the instructions are further operable, when executed by the one or more computers, to cause the dual validation authentication system to, upon generating the first dual validation work object, update the loss tracking client interface to comprise a status update indicating the acceptance of the dual validation data object.

In some embodiments, the instructions are further operable, when executed by the one or more computers, to cause the dual validation authentication system to, upon generating the set of dual validation work objects including the first dual validation work object, store the set of dual validation work objects for a predetermined time period, wherein the set of dual validation work objects is caused to be transmitted upon expiration of the predetermined time period.

In some embodiments, the data extracted from the dual validation data object comprises a payor identifier, one or more payee identifiers, one or more account identifiers, a dual validation data object amount identifier, a dual validation data object issue date identifier, and a dual validation data object identifier.

In another embodiment, a method for providing dual validation authentication is provided. The method includes receiving a loss authentication data object from a client device, the loss authentication data object comprising loss authentication parameters. The method also includes comparing the loss authentication parameters to remote dual validation authorization criteria. The method also includes, in a circumstance where the loss authentication parameters are determined to satisfy the remote dual validation authorization criteria, outputting a dual validation authorization approval instruction. The method also includes receiving a dual validation data object from the client device, the dual validation data object comprising requester validation data and a requester validation image.

The method also includes determining whether data extracted from the dual validation data object satisfies a predefined threshold. The method also includes, in accordance with determining that the data extracted from the dual validation data object satisfies the predefined threshold, accessing secondary validation data and a secondary validation image. The method also includes generating a first dual validation work object based at least on the dual validation data object, the secondary validation data, and the secondary validation image. The method also includes generating a set of dual validation work objects including the first dual validation work object. The method also includes causing transmission of the set of dual validation work objects to initiate an electronic fund disbursement to an account associated with the client device.

In some embodiments of the method, the loss authentication parameters comprise one or more of a client identifier, a loan identifier, a loss date identifier, a loss amount identifier, and a loss cause identifier.

In some embodiments of the method, comparing the loss authentication parameters to the remote dual validation authorization criteria further comprises determining whether the loss amount identifier exceeds a predefined loss amount threshold, the loss authentication parameters being determined to satisfy the remote dual validation authorization criteria in a circumstance where the loss amount identifier does not exceed the predefined loss amount threshold.

In some embodiments, the method further includes initiating a remote dual validation client interface to be rendered at the client device, the remote dual validation client interface configured to capture at least the requester validation image. In some embodiments, the method further includes, upon receiving the dual validation data object, extracting textual data from the requester validation image of the dual validation data object.

In some embodiments, the method further includes, in accordance with determining that the data extracted from the dual validation data object fails to satisfy the predefined threshold, causing transmission of a notification to the client device, the notification comprising instructions for resubmission of the dual validation data object.

In some embodiments of the method, accessing the secondary validation data and the secondary validation image further comprises accessing an encrypted validation object comprising the secondary validation data and the secondary validation image. In some embodiments of the method, accessing the secondary validation data and the secondary validation image further comprises accessing a decryption key for the encrypted validation object. In some embodiments of the method, accessing the secondary validation data and the secondary validation image further comprises decrypting the encrypted validation object.

In some embodiments, the method further includes, in the circumstance where the loss authentication parameters are determined to satisfy the remote dual validation authorization criteria, generating a tracking identifier for the loss authentication data object. In some embodiments, the method further includes, in the circumstance where the loss authentication parameters are determined to satisfy the remote dual validation authorization criteria, initiating a loss tracking client interface to be rendered at the client device, the loss tracking client interface comprising an indication of the tracking identifier and configured to provide status updates associated with the loss authentication data object to a user of the client device.

In some embodiments, the method further includes, upon generating the first dual validation work object, updating the loss tracking client interface to comprise a status update indicating the acceptance of the dual validation data object.

In some embodiments, the method further includes, upon generating the set of dual validation work objects including the first dual validation work object, storing the set of dual validation work objects for a predetermined time period, wherein the set of dual validation work objects is caused to be transmitted upon expiration of the predetermined time period.

In some embodiments of the method, the data extracted from the dual validation data object comprises a payor identifier, one or more payee identifiers, one or more account identifiers, a dual validation data object amount identifier, a dual validation data object issue date identifier, and a dual validation data object identifier.

### BRIEF DESCRIPTION OF THE SEVERAL VIEWS OF THE DRAWINGS

Reference will now be made to the accompanying drawings, which are not necessarily drawn to scale, and wherein:

FIG. 1 shows a schematic view of a dual validation authentication system disposed in communication with associated services according to various embodiments of the present disclosure;

FIG. 2 shows a schematic view of a dual validation authentication apparatus configured according to one embodiment;

FIG. 3A shows a flowchart illustrating steps for an authentication process that includes processing of a loss authentication data object by a dual validation authentication system in accordance with various embodiments of the present disclosure;

FIG. 3B shows a flowchart illustrating steps for a dual validation process that includes processing a dual validation data object by a dual validation authentication system in accordance with various embodiments of the present disclosure;

FIG. 4A shows an example loss authentication user interface configured to cause creation and transmission of a loss authentication data object in accordance with various embodiments of the present disclosure;

FIG. 4B shows example loss tracking client interfaces configured to cause creation and transmission of a dual validation data object in accordance with various embodiments of the present disclosure;

FIG. 4C shows an example remote dual validation client interface configured to cause creation and transmission of requester validation data and/or requester validation images in accordance with various embodiments of the present disclosure;

FIG. 4D shows example validation data review interfaces configured to cause creation and transmission of a loss authentication data object in accordance with various embodiments of the present disclosure;

FIG. 4E shows an example dual validation object error user interface configured for providing an error indication associated with submission of a dual validation data object in accordance with various embodiments of the present disclosure;

FIG. 4F shows an example dual validation object submission user interface configured for providing one or more requester validation images in accordance with various embodiments of the present disclosure;

FIG. 4G shows an example dual validation object submission user interface configured for providing one or more requester validation images in accordance with various embodiments of the present disclosure;

FIG. 5 shows a flowchart illustrating steps for accessing and decrypting secondary validation data and secondary validation images in accordance with various embodiments of the present disclosure; and

FIG. 6 shows a flowchart illustrating steps for generating and causing transmission of a set of dual validation data objects by a dual validation authentication system in accordance with various embodiments of the present disclosure.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

### Overview

Remote deposit systems that are configured to allow users to capture and deposit checks and/or other financial instruments remotely by using their personal mobile devices offer enhanced user experiences. For example, remote deposit systems provide convenience in that users save time by not needing to travel to a banking branch or automated teller machines in order to physically deposit checks. However, considerable technical challenges are introduced in circumstances where multiple independent systems must authenticate and validate a financial instrument associated with a mobile deposit.

For example, a financial instrument such as a physical check that is issued to an example individual, Sally, by an example insurance company, Alpha Insurance Company, may require endorsement not only by Sally but also by one or more additional entities, such as a financial institution (e.g., Acme Commerce Bank). For instance, the physical check may be associated with monetary reimbursement for a loss incurred by Sally regarding a piece of property that may be insured by Alpha Insurance Company but also be mortgaged to Sally by Acme Commerce Bank. In this regard, upon an endorsement and a subsequent mobile deposit of the physical check by Sally, a unique data object may be programmatically generated that encapsulates information associated with the financial instrument.

Given the need for additional validation of the financial instrument by one or more other entities, a variety of technical challenges emerge in route to the goal of financial reimbursement to Sally. For example, the data object may need to be received, processed, and transmitted by multiple disparate systems that each require data in a specific format. In this regard, the data object and/or the system handling generation of the data object should be configured to communicate and alter the data object to meet the needs of the disparate systems.

Additionally, given that multiple (e.g., hundreds or thousands) financial instruments may be issued and/or deposited daily, embodiments herein provide an efficient means of validating the financial instruments such that impact on bandwidth or additional processing between systems is reduced and/or eliminated. For example, embodiments herein detail criteria which, if satisfied, allow for automatic retrieval and use of secondary validation data to eliminate the need for additional network communication and consumption of processing resources associated with one or more additional entities.

### Definitions

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

As used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, the term “user” and/or “client” should be understood to refer to an individual or entity. The users referred to herein are enabled to access functionalities associated with a dual validation authentication system using client devices. Each user is associated with at least one client identifier. As used herein, the term “client identifier” refers to one or more items of data by which a particular user and/or client device associated with the user may be uniquely identified. For example, in one embodiment, a client identifier may be stored as an unsigned integer and represented externally (outside of memory) as a base-34 encoded string. In other embodiments, the client identifier may comprise a combination of American Standard Code For Information Interchange (ASCII) characters.

The term “client device” refers to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like. Client devices, as described herein, communicate with and otherwise access a dual validation authentication system, via one or more networks.

The term “dual validation authentication system” refers to a software and hardware system that is configured to support dual validation and authentication processes associated with dual validation data objects. For example, a dual validation authentication system is configured to receive inputs such as loss authentication data objects as part of an authentication process. The dual validation authentication system then receives dual validation data objects from client devices and processes these inputs accordingly to generate dual validation work objects as part of a dual validation process. Such dual validation work objects are configured to initiate electronic fund disbursements to accounts associated with such client devices. Dual validation authentication systems may be configured to communicate with various devices and services through a dual validation application programming interface (API).

The term “data object” refers to a structured arrangement of data. A “loss authentication data object” is a structured set of data and instructions issued by a specifically configured software application or “app” running on a client device to a dual validation authentication system. The loss authentication data object includes one or more “loss authentication parameters” associated with a loss draft claim transmitted by a user via a client device associated with a particular insurance policy, covered asset, and loan account. A loss authentication data object comprises loss authentication parameters that include, for example, a client identifier, a loan identifier, a loss date identifier, a loss amount identifier, and a loss cause identifier. A loss authentication data object is received by the dual validation authentication system and parsed to determine whether to output a dual validation authorization approval instruction.

The term “dual validation authorization approval instruction” refers to an instruction, command, or signal that is output by a dual validation authentication system that is configured to confirm or initiate issuance of a monetary reimbursement instrument (e.g., a physical check and/or the like) to a user under an authenticated loss draft insurance policy. In some embodiments, the dual validation authorization approval instruction is output to a service responsible for issuance of the monetary reimbursement item. The output of a dual validation authorization approval instruction by the dual validation authentication system may be based on loss authentication parameters of a loss authentication data object having been determined to satisfy remote dual validation authorization criteria stored by the dual validation authentication system.

The term “dual validation data object” refers to a structured data object that includes one or more sets of data that alone or in combination with other sets of data provide information about a requested or expected electronic fund disbursement associated with a loss draft claim that can be used to generate one or more dual validation work objects. A dual validation data object may comprise data, including metadata, such as a payor identifier, one or more payee identifiers, one or more account identifiers, a dual validation data object amount identifier, a dual validation data object issue date identifier, and a dual validation data object identifier. A dual validation data object also comprises requester validation data and a requester validation image. A dual validation data object may be generated at and received from a client device. Data contained in a dual validation data object may be parsed or otherwise extracted and used by the dual validation authentication system to access secondary validation data and generate a dual validation work object.

The term “loan identifier” refers to one or more items of data by which a particular agreement between two or more parties may be uniquely identified. In some embodiments, a loan identifier may be included as a loss authentication parameter within a loss authentication data object received by a dual validation authentication system from a client device. For example, a loan identifier may comprise ASCII text, a pointer, a memory address, and the like.

The term “loss date identifier” refers to one or more items of data by which a loss incurred by a user may be uniquely identified. In some embodiments, a loss date identifier may be included as a loss authentication parameter within a loss authentication data object received by a dual validation authentication system from a client device For example, a loss date identifier may comprise ASCII text, a pointer, a memory address, and the like.

The term “loss amount identifier” refers to one or more items of data by which a monetary amount associated with a loss incurred by a user may be uniquely identified. In some embodiments, a loss amount identifier may be included as a loss authentication parameter within a loss authentication data object received by a dual validation authentication system from a client device For example, a loss amount identifier may comprise ASCII text, a pointer, a memory address, and the like.

The term “loss cause identifier” refers to one or more items of data that identifies a description, reasoning, and/or other information regarding a cause of a loss incurred by a user. In some embodiments, a loss cause identifier may be included as a loss authentication parameter within a loss authentication data object received by a dual validation authentication system from a client device For example, a loss cause identifier may comprise ASCII text, a pointer, a memory address, and the like.

The term “payor identifier” refers to one or more items of data by which a payor associated with a dual validation data object may be uniquely identified. In some embodiments, a loss cause identifier may be included within a dual validation data object received by a dual validation authentication system from a client device For example, a payor identifier may comprise ASCII text, a pointer, a memory address, and the like.

The term “payee identifier” refers to one or more items of data by which one or more payees associated with a dual validation data object may be uniquely identified. In some embodiments, a payee identifier may be included within a dual validation data object received by a dual validation authentication system from a client device For example, a payee identifier may comprise ASCII text, a pointer, a memory address, and the like.

The term “account identifier” refers to one or more items of data by which one or more accounts (e.g., accounts in which electronic funds may be disbursed and/or allocated to, such as bank accounts and/or the like) associated with a user may be uniquely identified. In some embodiments, an account identifier may be included within a dual validation data object received by a dual validation authentication system from a client device For example, an account identifier may comprise ASCII text, a pointer, a memory address, and the like.

The term “dual validation data object amount identifier” refers to one or more items of data by which one or more accounts (e.g., accounts in which electronic funds may be disbursed and/or allocated to, such as bank accounts and/or the like) associated with a user may be uniquely identified. In some embodiments, a dual validation data object amount identifier may be included within a dual validation data object received by a dual validation authentication system from a client device For example, a dual validation data object amount identifier may comprise ASCII text, a pointer, a memory address, and the like.

The term “dual validation data object issue date identifier” refers to one or more items of data by which an issue date associated with a dual validation data object may be uniquely identified. In some embodiments, an dual validation data object issue date identifier may be included within a dual validation data object received by a dual validation authentication system from a client device For example, a dual validation data object issue date identifier may comprise ASCII text, a pointer, a memory address, and the like.

The term “dual validation data object identifier” refers to one or more items of data by which a dual validation data object may be uniquely identified. In some embodiments, a dual validation data object identifier may be included within a dual validation data object received by a dual validation authentication system from a client device. For example, a dual validation data object identifier may comprise ASCII text, a pointer, a memory address, and the like.

The term “remote dual validation authorization criteria” refers to information that may be stored by a dual validation authentication system and used to compare with loss authentication parameters of a loss authentication data object received by the dual validation authentication system in order to determine whether the loss authentication parameters are sufficient for the dual validation authentication system to output a dual validation authorization approval instruction. For example, a loss amount identifier of the loss authentication parameters may be compared with a predefined loss amount threshold of the remote dual validation authorization criteria to determine whether the loss amount identifier exceeds the predefined loss amount threshold.

The term “requester validation data” refers to information included in a dual validation data object that may be extracted and used by a dual validation authentication system to determine whether the dual validation data object is a valid and/or authentic dual validation data object. For example, requester validation data may include identifiers such as a payor identifier, one or more payee identifiers, one or more account identifiers, a dual validation data object amount, a dual validation data object issue date, a dual validation data object identifier, and/or the like, as described above.

The term “requester validation image” refers to a digital image (e.g., a Joint Photographic Experts Group (JPEG) image) of a monetary reimbursement item (e.g., a physical check and/or the like). A requester validation image may be captured and/or generated by a user (e.g., via a camera associated with a client device) and included as a portion of a dual validation data object. The requested validation image may include a set of images (e.g., the front and back of a physical check depicting a user endorsement) that are configured for validation during a dual validation process. A dual validation authentication system may extract data from a requester validation image to determine information regarding the dual validation data object that may be necessary to determine whether to apply secondary validation (e.g., an endorsement associated with a secondary party) to generate a dual validation work object. In some embodiments, a requester validation image may be captured at the client device through use of a remote dual validation client interface.

The term “remote dual validation client interface” refers to a user interface (UI) that may be rendered at a client device and configured to capture and generate a requester validation image and/or enable a user of the UI to communicate and/or perform other operations associated with a dual validation authentication system. Rendering of a remote dual validation client interface at a client device may be initiated by a dual validation authentication system (e.g., through one or more networks).

The term “secondary validation data” refers to structured data, including metadata, associated with a secondary party associated with a dual validation data object that may be used to generate a dual validation work object. Secondary validation data may be accessed and retrieved from a repository or other storage medium internal or external to a dual validation authentication system. In some embodiments, secondary validation data may be accessed and retrieved in response to a determination by the dual validation authentication system that data extracted from a dual validation data object satisfies a predefined threshold. In other embodiments, secondary validation data may be accessed and retrieved in response to a determination by the dual validation authentication system that (i) data extracted from a dual validation data object satisfies a predefined threshold, and (ii) a requested validation image from the dual validation data object satisfies certain validation criteria (e.g., an image of a user signature endorsement for a particular dual validation object matches, by a defined probability threshold, a file signature associated with a loan policy).

The term “secondary validation image” refers to image data associated with a secondary party associated with a dual validation data object that may be used to generate a dual validation work object. In some embodiments, a secondary validation image may comprise an image of a signature, stamp, and/or other type of endorsement associated with the secondary party which can be used to further validate a dual validation data object. A secondary validation image may be accessed and retrieved from a repository or other storage medium internal or external to a dual validation authentication system. In some embodiments, a secondary validation image may be accessed and retrieved in response to a determination by the dual validation authentication system that data extracted from a dual validation data object satisfies a predefined threshold. In some embodiments, one or more secondary validation images may be stored in association with secondary validation data as structured data herein referred to as a “validation object.”

The term “encrypted validation object” refers to a validation object that has been stored in an encrypted format. An encrypted validation object is associated with a unique “decryption key” that can be used by a dual validation authentication system to decrypt the encrypted validation data object and access secondary validation data and one or more secondary validation images.

The term “dual validation work object” refers to a data object that has been specially structured by a dual validation authentication system such that an accounting conduit service may process the dual validation work object when received from the dual validation authentication system. A dual validation work object comprises information based on a dual validation data object, secondary validation data, and a secondary validation image.

The term “tracking identifier” refers to one or more items of data by which information associated with a loss authentication data object may be uniquely identified. In some embodiments, an dual validation data object issue date identifier may be included within a dual validation data object received by a dual validation authentication system from a client device. For example, a dual validation data object issue date identifier may comprise ASCII text, a pointer, a memory address, and the like.

The term “loss tracking client interface” refers to a UI that may be rendered at a client device and configured to provide notifications, confirmations, and/or other status updates associated with a loss authentication data object to a user of the client device and/or perform other operations associated with a dual validation authentication system. A loss tracking client interface may include indications of various information, including a tracking identifier and/or other identifiers associated with a loss authentication data object. Rendering of a loss tracking client interface at a client device may be initiated by a dual validation authentication system (e.g., through one or more networks).

### Example System Overview

Systems and methods of the present disclosure may be embodied by any of a variety of devices. For example, the Systems and methods of an example embodiment may be embodied by a networked computing device (e.g., an enterprise platform), such as a server or other network entity, configured to communicate with one or more devices, such as one or more client devices, and one or more external services. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

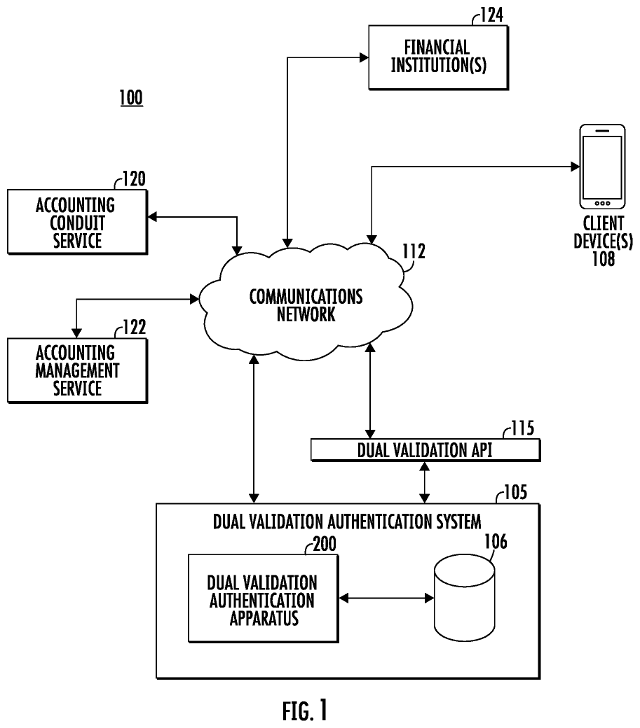

FIG. 1 illustrates an example computing environment 100 within which embodiments of the present disclosure may operate. Users may communicate with a dual validation authentication system 105 via a communications network 112 using client devices 108. The dual validation authentication system 105 may comprise a dual validation authentication apparatus 200 in communication with at least one repository 106.

Communications network 112 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, communications network 112 may include a cellular telephone, an 802.11, 802.16, 802.20, and/or WiMax network. Further, the communications network 112 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the dual validation authentication system 105.

The dual validation authentication apparatus 200 may be embodied as a computer or computers. The dual validation authentication apparatus 200 may provide for receiving of electronic data from various sources, including but not limited to client devices 108. For example, the dual validation authentication apparatus 200 may be operable to receive loss authentication data objects and dual validation data objects provided by the client devices 108.

The repository 106 may be embodied as a data storage device such as a Network Attached Storage (NAS) device or devices, or as a separate database server or servers. The repository 106 includes information accessed and stored by the dual validation authentication system 105 to facilitate the operations of the dual validation authentication system 105. For example, the repository 106 may store, without limitation, data such as loss authentication data objects, remote dual validation authorization criteria, dual validation data objects, secondary validation data, secondary validation images, dual validation work objects, and/or other data to facilitate the operations of the dual validation authentication system 105.

The client devices 108 may be any computing device as defined above. Electronic data that is received by the dual validation authentication system 105 from the client devices 108 may be provided in various forms and via various methods. For example, the client devices 108 may include desktop computers, laptop computers, smartphones, netbooks, tablet computers, wearables, and the like.

Additionally, or alternatively, in some embodiments, the dual validation authentication system 105 may be configured, via software, hardware, or a combination thereof, to perform one or more of the operations disclosed herein with respect to managing loss authentication data objects, dual validation data objects, and/or the like. For example, the dual validation authentication system may be configured with one or more application programming interfaces (APIs) 115 accessible to client devices 108 and/or other external sources.

In embodiments where a client device (e.g., a client device 108) is a mobile device, such as a smartphone, laptop, tablet, or the like, the client device may execute an application, or “app,” to interact with the dual validation authentication system 105. Such apps are typically designed to execute on mobile devices, such as tablets or smartphones. For example, an app may be provided that executes on mobile device operating systems such as iOS®, Android®, Windows® or the like. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

Additionally, or alternatively, client devices may interact with the dual validation authentication system 105 via a web browser. As yet another example, client devices may include various hardware or firmware designed to interface with the dual validation authentication system 105.

In an example embodiment, the dual validation authentication system 105 may also comprise, be connected to, or otherwise be in communication with an accounting conduit service 120. The accounting conduit service 120 may be a service internal to the dual validation authentication system in some embodiments, or external to the dual validation authentication system 105 in other embodiments (e.g., as a third-party service). In some embodiments, the accounting conduit service may serve as a conduit between the dual validation authentication system 105 and one or more financial institutions 124. The accounting conduit service 120 may receive dual validation work objects or sets of dual validation work objects from a dual validation authentication system 105 and cause transmission of the dual validation work objects or sets of dual validation work objects to one or more financial institutions 124 for electronic fund disbursement and/or other processing. The accounting conduit service 120 may process received dual validation work objects in order to update accounting records for a service associated with the dual validation authentication system 105. Such processing may include, for example, digitally recording accounts payable and/or receivable transactions, digitally updating a general ledger, digitally organizing the dual validation work objects into file transfer protocol (FTP) packages for transmission to a respective associated financial institution, and/or other processing.

In an example embodiment, the dual validation authentication system 105 may also comprise, be connected to, or otherwise be in communication with an account management service 122. The accounting conduit service 120 may be a service internal to the dual validation authentication system in some embodiments, or external to the dual validation authentication system 105 in other embodiments (e.g., as a third-party service). In some embodiments, the account management service 122 may receive data associated with dual validation work objects and/or sets of dual validation work objects from a dual validation authentication system 105 and process such data to ensure electronic funds are provided to a clearing account in order to satisfy mobile deposit of electronic funds to a user's account.

In an example embodiment, the dual validation authentication system 105 may also be connected to, or in communication with one or more financial institutions, such as banks and/or the like, that may provide automated clearing house (ACH) and/or deposit processes for accounts associated with a user. For example, in some embodiments, the financial institution(s) are in communication with the accounting conduit service 120 from which the financial institution(s) may receive data, such as dual validation work objects, and/or the like.

### Example Apparatus for Implementing Embodiments of the Present Disclosure

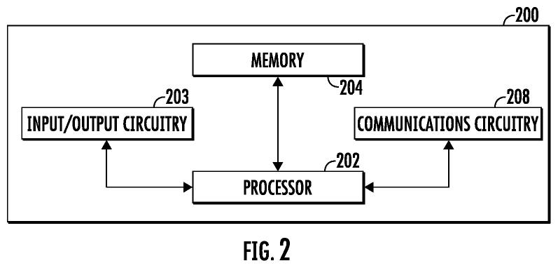

The dual validation authentication system 105 may comprise or be embodied by one or more computing systems, such as dual validation authentication apparatus 200 shown in FIG. 2. The dual validation authentication apparatus 200 may include a processor 202, a memory 204, input/output circuitry 203, and communications circuitry 208. The dual validation authentication system 105, by way of the dual validation authentication apparatus 200 may be configured, using the memory 204 and/or one or more of the circuitry 202, 203, and 208 to execute the operations described herein.

Although the components are described with respect to functional limitations, it should be understood that the particular implementations necessarily include the use of particular hardware. It should also be understood that certain components of the components described herein may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry,” as defined above, should be understood broadly to include hardware and, in some embodiments, software for configuring the hardware. For example, in some embodiments, “circuitry” may include processing circuitry, storage media, network interfaces, input/output devices, and the like. In some embodiments, other elements of the apparatus 205 may provide or supplement the functionality of particular circuitry. For example, the processor 202 may provide processing functionality, the memory 204 may provide storage functionality, the communications circuitry 208 may provide network interface functionality, and the like.

In some embodiments, the processor 202 (and/or co-processor or any other processing circuitry assisting or otherwise associated with the processor) may be in communication with the memory 204 via a bus for passing information among components of the apparatus. The memory 204 may be non-transitory and may include, for example, one or more volatile and/or non-volatile memories. In other words, for example, the memory may be an electronic storage device (e.g., a computer readable storage medium). The memory 204 may be configured to store information, data, content, applications, instructions, or the like, for enabling the dual validation authentication apparatus 200 to carry out various functions in accordance with example embodiments of the present disclosure.

The processor 202 may be embodied in a number of different ways and may, for example, include one or more processing devices configured to perform independently. Additionally, or alternatively, the processor may include one or more processors configured in tandem via a bus to enable independent execution of instructions, pipelining, and/or multithreading. The use of the term “processor” may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor. Alternatively, or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor is embodied as an executor of software instructions, the instructions may specifically configure the processor to perform the algorithms and/or operations described herein when the instructions are executed.

In some embodiments, the dual validation authentication apparatus 200 may include input/output circuitry 203 that may, in turn, be in communication with processor 202 to provide output to the user and, in some embodiments, to receive an indication of a user input. The input/output circuitry 203 may comprise a user interface and may include a display and may comprise a web user interface, a mobile application, a client device, a kiosk, or the like. In some embodiments, the input/output circuitry 203 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the dual validation authentication apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna(s) to cause transmission of signals via the antenna(s) or to handle receipt of signals received via the antenna(s).

The communications circuitry 208 includes hardware and software configured to support a dual validation authentication system 105. The communications circuitry 208 may utilize processing circuitry, such as the processor 202, to perform these actions. It should also be appreciated that, in some embodiments, the communications circuitry 208 may include a separate processor, specially configured field programmable gate array (FPGA), or application specific interface circuit (ASIC).

It is also noted that all or some of the information discussed herein can be based on data that is received, generated and/or maintained by one or more components of the dual validation authentication system 105. In some embodiments, one or more external systems (such as a remote cloud computing and/or data storage system, an accounting conduit service 120, an account management service 122, one or more financial institutions 124, and/or the like) may also be leveraged to provide at least some of the functionality discussed herein.

As described above and as will be appreciated based on this disclosure, embodiments of the present disclosure may be configured as methods, mobile devices, frontend graphical user interfaces, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus's circuitry to produce a machine, such that the computer, processor, or other programmable circuitry that execute the code on the machine creates the means for implementing various functions, including those described herein.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### Example Processes

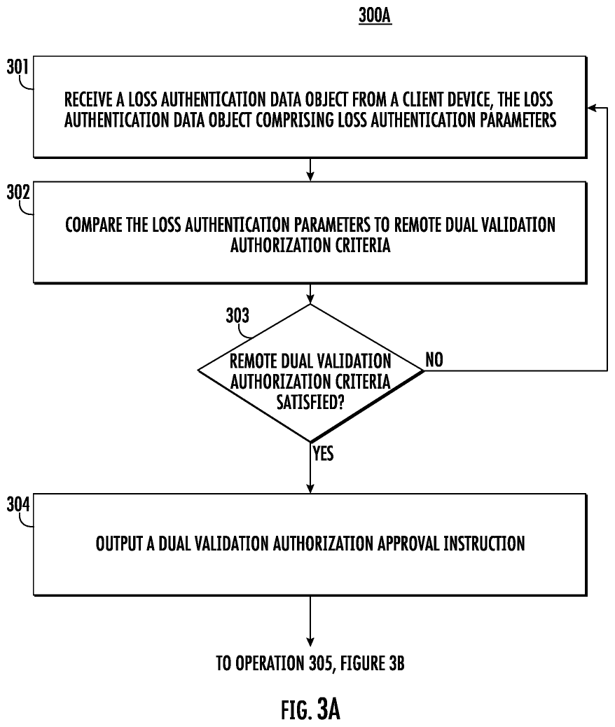

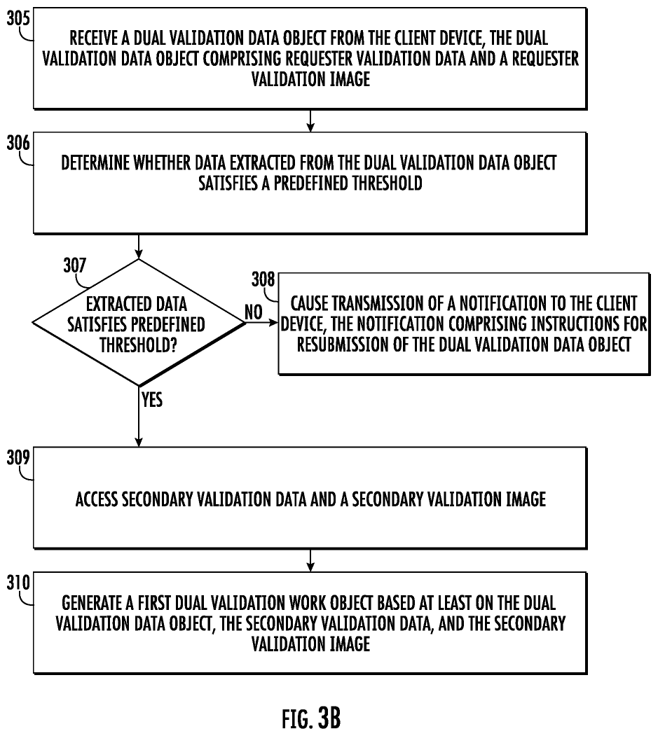

In embodiments, the dual validation authentication system 105 is configured to manage receipt and processing of loss authentication data objects as part of an authentication process in accordance with operations of the method 300A illustrated in FIG. 3A.

The depicted authentication process begins at operation 301 wherein the dual validation authentication apparatus 200 receives a loss authentication data object. The dual validation authentication apparatus 200 may receive a loss authentication data object from a client device via communications circuitry 208 and/or communications network 112. In one embodiment, the loss authentication data object may be received upon a user at the client device 108 interacting with one or more graphical user interfaces, e.g., within a software application running on the client device initiated, hosted, and/or supported by the dual validation authentication system 105. For example, a user interface rendered at the client device 108 may comprise one or more user interface elements associated with generating and causing transmission of a loss authentication data object to the dual validation authentication system 105.

In one example, a loss authentication data object may be generated and transmitted to a dual validation authentication system 105 in a circumstance in which a user wishes to file an insurance claim (e.g., a loss draft claim) on an insured property that the user has incurred a loss on. In addition to the user and an insurance company insuring the property, another party, such as a financial institution (e.g., a bank), may also have an interest in the loss (e.g., the financial institution may hold a mortgage that is secured by the property incurring the loss) and therefore has an interest in ensuring that any funds provided by the insurance company under the associated insurance policy are appropriately applied to rehabilitate the property in view of a covered loss.

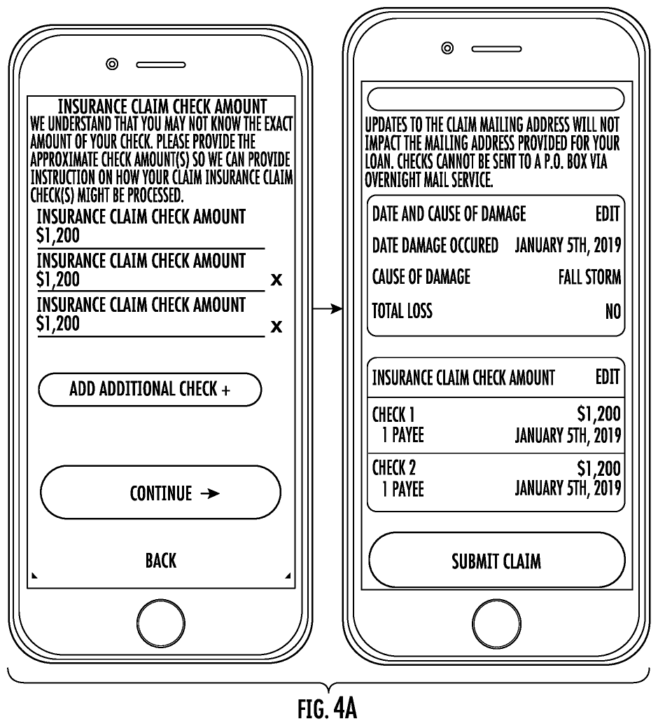

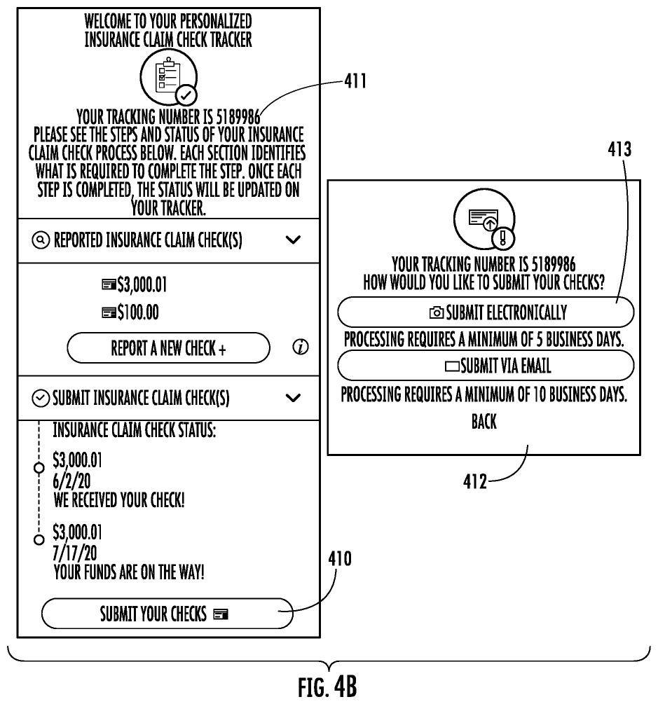

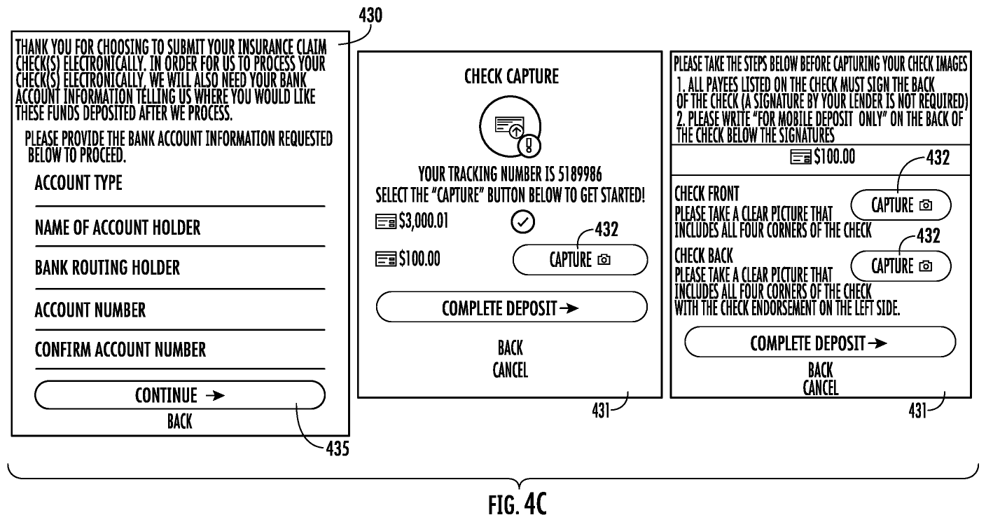

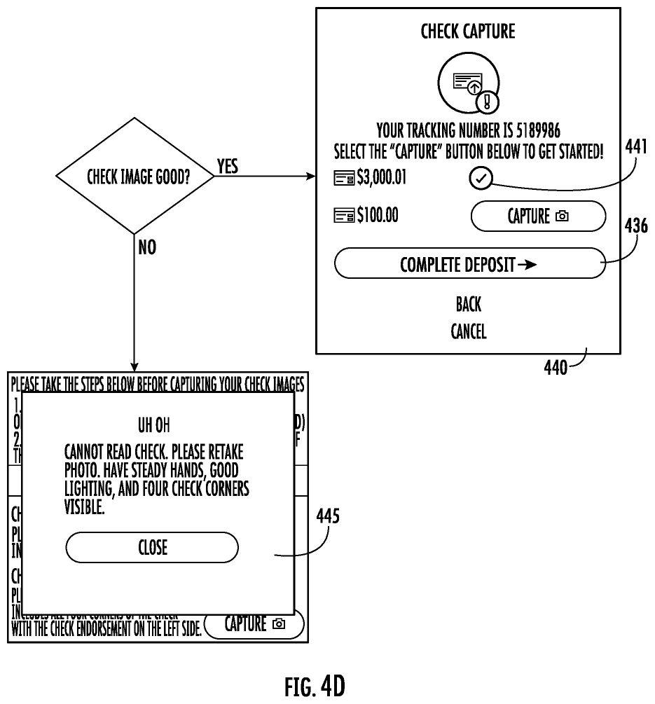

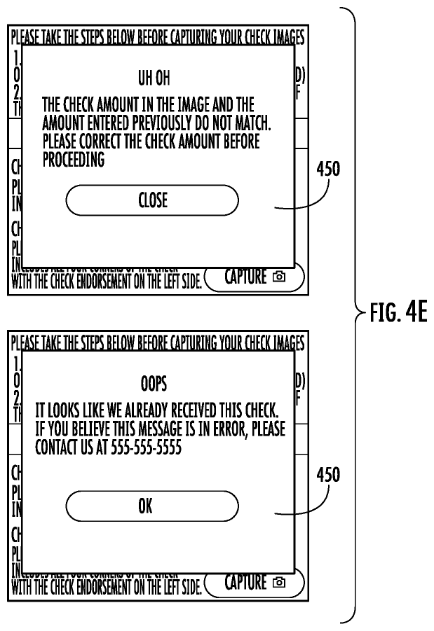

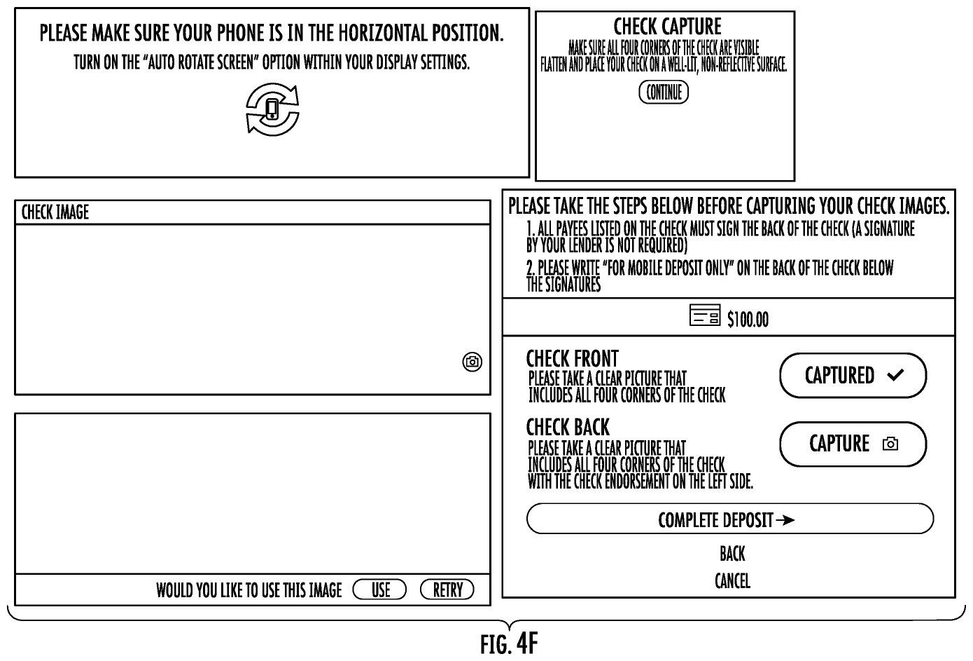

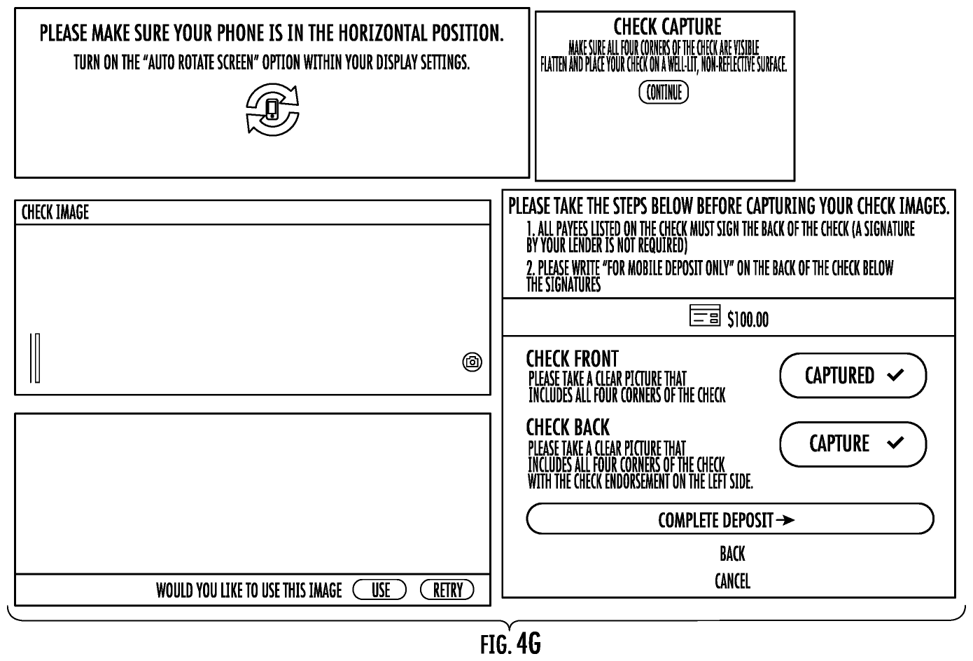

An example loss authentication user interface which may be initiated by the dual validation authentication system 105 and rendered at a client device 108 is depicted in FIG. 4A. As shown, a user may be prompted by the loss authentication user interface to enter information regarding the claim, such as one or more claim check amounts or an estimated claim check amounts (e.g., a monetary amount the user has received or expects to receive in the form of a check), as well as other information that when entered by the user results in the generation of loss authentication parameters. As described above, loss authentication parameters can include a client identifier, a loan identifier, a loss date identifier, a loss amount identifier, a loss cause identifier, and/or other information. Upon the user selecting the “Submit Claim” button shown in FIG. 4A, a loss authentication data object comprising the loss authentication parameters is transmitted to the dual validation authentication system 105 such that the dual validation authentication system can initiate the authentication process.

Upon receiving the loss authentication data object, as part of the authentication process, the loss authentication parameters may be parsed (e.g., by API 115) in order to check for any errors. In this regard, the dual validation authentication system 105, through use of the API 115, processor 202, and the like, determines whether all necessary information for processing the loss authentication data object is included in the loss authentication parameters. For example, the API 115 may assign data to a number of predefined fields to ensure that all fields are assigned data and that no data is missing. Example fields that may be assigned data may include a loss date field (e.g., filled via information associated with the loss date identifier), a loss cause field (e.g., filled via information associated with the loss cause identifier), a check amount field (e.g., filled via information associated with the loss amount identifier), a client ID field (e.g., filled via information associated with the client identifier), and other fields.

If fields are determined to be missing, the dual validation authentication system 105 may initiate a user interface at the client device 108 that comprises an error message regarding the submitted claim. For example, the error message may include indications of missing information and prompt the user to resubmit the claim.

If no errors are determined, at operation 302, the dual validation authentication system 105 compares the loss authentication parameters to remote dual validation authorization criteria. The dual validation authentication system 105 may compare the loss authentication parameters to the remote dual validation authorization criteria via the processor 202, memory 204, and/or the like. In some embodiments, the remote dual validation authorization criteria may be accessed from the repository 106.

The remote dual validation authorization criteria may include various criteria which the loss authentication parameters must satisfy in order to continue processing of the claim and/or provision of a reimbursement for the submitted claim to take place. As one example, the loss amount identifier included in the loss authentication parameters may be compared with a predefined loss amount threshold. For example, it may be predetermined that loss amounts totaling $5,000 or less satisfy the remote dual validation authorization criteria. In this regard, loss amounts totaling more than $5,000 may be subject to additional review (e.g., by one or more parties involved in the transaction). The dual validation authentication system 105 determines, via the processor 202, memory 204, and/or the like, whether the loss amount identifier exceeds a predefined loss amount threshold. At decision point 303, if the remote dual validation authorization criteria are not satisfied (e.g., if the loss amount exceeds $5,000 in the above example), the method 300A may return to operation 301. In this regard, a notification may be provided to the client device indicating that additional review is needed regarding the submitted loss authentication data object, and, if necessary, a new or updated loss authentication data object may be received.

If the remote dual validation authorization criteria is determined to be satisfied, the method 300A continues to operation 304, wherein the dual validation authentication system, via the processor 202, memory 204, input/output circuitry, and/or the like, completes the authentication process by outputting a dual validation authorization approval instruction. In some embodiments, the dual validation authorization approval instruction may comprise one or more instructions to generate and store a data object configured to contain data regarding the submitted loss authentication data object. Storage of this data object may enter the claim in a data queue wherein the claim is reviewed (e.g., by the insurance company or other party) in order to create a monetary reimbursement instrument (e.g., a reimbursement check) for the claim. For example, the data object may include a tracking identifier that may be generated for the claim that can be provided to the user of the client device in order to track the status of the claim. Additionally, stored data can include an indication of a classification of the claim. Further, stored data (e.g., in repository 106) associated with the user that submitted the loss authentication data object (e.g., based on a client identifier) may be updated in light of data submitted with the loss authentication data object. For example, data records indicative of a home address, email address, phone number, and/or the like associated with the client identifier may be automatically updated in order to ensure up-to-date contact information for the user such that any materials related to the submitted claim are delivered appropriately.

Additionally, in some embodiments, if the remote dual validation authorization criteria is determined to be satisfied, the dual validation authentication system 105 may initiate a loss tracking client interface rendered at the client device. As shown in FIG. 4B, the loss tracking client interface may include an indication of a tracking identifier 411 and be configured to provide status updates associated with the loss authentication data object to a user of the client device. As shown, for example, the user interface may include instructions regarding next steps the user should take in the claim process. For example, the loss tracking client interface may include a selectable icon 410 or the like for the user to select once a physical insurance claim check has been received.

Upon user selection of the icon 410, in some embodiments, an additional loss tracking client interface 412 may be rendered, providing several options for submittal of a financial instrument (e.g., a physical check). For example, the user may select to submit the check via mail, or submit the check electronically by selecting icon 413. Upon user selection of the icon 413, in some embodiments, an indication may be transmitted from the client device to the dual validation authorization system 105 and in response, the dual validation authorization system 105, via the processor 202, communications circuitry 208, and/or the like, initiates a remote dual validation client interface to be rendered at the client device. The remote dual validation client interface is configured to capture various data regarding the physical check received by the user, including at least a requester validation image. Example interfaces of a remote dual validation client interface are depicted in FIG. 4C. As shown, the remote dual validation client interface may include a first interface 430 comprising fillable fields in which the user may enter personal account information (e.g., an account number, bank routing number, account holder name, etc.) for an account the user intends to have funds in the amount of the check deposited. As shown, for example, the user may click the “continue” icon 435 to continue to additional second interfaces 431. The second interfaces 431 may include one or more icons 432 which the user may select in order to capture a requester validation image (e.g., an image of the physical check). Upon selection of the icon 432, additional interfaces as shown in FIG. 4F and FIG. 4G may be presented, e.g., utilizing an associated camera or other image capture device of the client device 108 in order to capture a requester validation image, which may include a front image and a back image of the check. The back image may contain, for example, an endorsement (e.g., a signature) of the user.

The “Complete Deposit” icon 436 may be an inactive icon and unavailable for selection until the dual validation authentication system 105 validates the image of the check to ensure data is captured appropriately. Turning to FIG. 3B, operations associated with a dual validation process performed by the dual validation authentication system are shown. In some embodiments, once the requester validation image is captured at the client device, at operation 305, the dual validation authentication system 105, via the processor 202, communications circuitry 208, and/or the like, receives a dual validation data object from the client device, the dual validation data object comprising requester validation data and a requester validation image, and thus initiating a dual validation process by the dual validation authentication system. The dual validation authentication system 105, via the processor 202, memory 204, API 115 and/or the like, may then extract textual data from the requester validation image. For example, using the API 115, various fields may be assigned for the check. Table A below shows various fields that may be assigned based on information extracted from the requester validation image.

TABLE A
Incoming - Deposit Check API
API Fields

| “uniqueId”: | |
|---|---|
| “clientId”, | |
| “loanNumber”, | |
| “trackingNo”, | |
| “phoneNumber”, | |
| “bankRecordId”, | |
| “checks”: | [ |
| | { |
| | “checkIdentifier”, |
| | “checkNo”, |
| | “checkIssueDate”, |
| | “checkAmount”, |
| | “frontImage”, |
| | “backImage””, |
| | “micr”, |
| | “checkAccountNumber”, |
| | “checkRoutingNumber”, |
| | “payor”, |
| | “payee1FirstName”, |
| | “payee1LastName”, |
| | “payee2FirstName”, |
| | “payee2LastName”, |
| | “payee3FirstName”, |
| | “payee3LastName” |
| | } |
| | ] |

In this regard, at operation 306, the dual validation authentication system 105, via the processor 202, memory 204, and/or the like, determines whether data extracted from the dual validation data object satisfies a predefined threshold. For example, if all or a predefined number of fields are assigned data based on information extracted from the requester validation image, and/or the requester validation image from the dual validation data object satisfies certain validation criteria (e.g., an image of a user signature endorsement for a particular dual validation object matches, by a defined probability threshold, a file signature associated with a loan policy), it may be determined that the requester validation image is valid to submit as part of a dual validation data object. Additional validation data review interfaces as shown in the example interfaces of FIG. 4D may then be initiated by the dual validation authentication system and rendered to the client device 108. If the requester validation image is valid, interface 440 may be rendered, including an indication 441 (e.g., a check mark) that the captured requester validation image is acceptable. Additionally, the “Complete Deposit” icon 436 may now be active and selectable by the user in response to the validation of the requester validation image.

Alternatively, at decision point 307, if the extracted data does not satisfy the predefined threshold, (e.g., if the requester validation image is determined to be invalid, for example such that certain fields are unable to be assigned based on missing and/or unreadable data of the requester validation image, the process may continue to operation 308, wherein the dual validation authentication system, via the processor 202, communications circuitry 208, and/or the like, causes transmission of a notification to the client device, the notification comprising instructions for resubmission of the dual validation data object. For example, an example interface 445 may be rendered, providing an indication of a description of the error and/or a required action by the user, such as a recapture and/or resubmission of the requester validation image.

In some embodiments, upon selection of the “Complete Deposit” icon 436 of interface 440, additional validation of the dual validation data object may be performed. For example, a dual validation data object amount identifier, which may indicate an amount on one or more checks, may be compared to a stored initial check collection amount (e.g., stored in repository 106) to ensure a match between the two amounts and that the check amount has not been altered in any manner or that the check has not already been previously submitted. Additionally, account details included in the requester validation data of the dual validation data object (e.g., account numbers, routing numbers, etc.) may be verified with data stored in the repository 106, such as previous account information stored for that particular user.

Additionally, stored data records (e.g., in repository 106), such as the data object configured to track the particular claim may be updated. For example, the claim may be re-classified in some embodiments based on the successful submission of the requester validation image and/or various data that was extracted from the requester validation image and/or provided by the dual validation data object.

In some embodiments, the dual validation authentication system may perform an additional check on the dual validation data object to ensure that the remote dual validation authorization criteria remains satisfied. In this regard, the dual validation authentication system 105, such as the processor 202, memory 204, and/or the like, may compare the dual validation data object amount identifier to the predefined loss amount threshold to ensure that the dual validation data object amount identifier is under the predefined loss amount threshold (e.g., $5,000 in the earlier example).

In this regard, if the remote dual validation authorization criteria is now determined to not satisfy (e.g., the loss authentication data object indicated a loss amount under $5,000 and the resulting dual validation data object amount identifier is higher than $5,000), the dual validation authentication system 105 may initiate a dual validation object error user interface 450 at the client device 108, as shown for example in FIG. 4E, which provides information to the user that the submitted checks do not qualify and/or are different from the information that was initially reported in the loss authentication data object.

After validation of the requester validation image and details associated therewith as described above (e.g., data extracted from a dual validation data object satisfies a predefined threshold and the user endorsement signature is determined to be valid), it may be determined by the dual validation authentication system 105 to apply secondary validation to the loss authentication data object. In this regard, the dual validation process may then continue to operation 309, wherein the dual validation authentication system 105, via the processor 202, memory 204, communications circuitry 208, and/or the like, accesses secondary validation data and a secondary validation image, e.g., in response to the validation of the requester validation image. In some embodiments, the secondary validation data and the secondary validation image may be stored as a validation data object, e.g., in repository 106, or an external storage source, such as a cloud-based storage service and/or the like. In some embodiments, the validation data object may be associated with another party that is associated with the submitted loss draft claim check. For example, the party may be a banking institution (e.g., a bank that holds the mortgage on the property that is the subject of the loss claim submitted by the user). In some embodiments, the secondary validation image may comprise an endorsement associated with the party (e.g., endorsement of the bank) that may be required for further processing of the check.

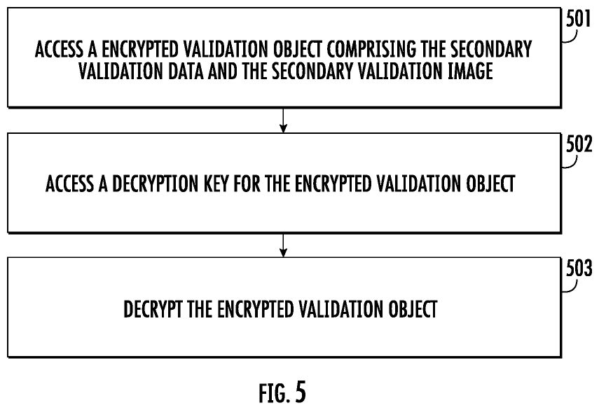

In some embodiments, the dual validation object may be encrypted, and may require a decryption key in order to decrypt the validation object and access the secondary validation data and the secondary validation image. Turning to FIG. 5, at operation 501, the dual validation authentication system, via the processor 202, memory 204, communications circuitry 208, and/or the like, accesses an encrypted validation object comprising the secondary validation data and the secondary validation image. For example, in some embodiments, the encrypted validation object may be accessed based on a party associated with the dual validation data object. For example, an endorsement by a particular financial institution may be needed to further process the check, and in response, a validation data object associated with that particular financial institution may be accessed.

At operation 502, the dual validation authentication system, via the processor 202, memory 204, communications circuitry 208, and/or the like, accesses a unique decryption key for the encrypted validation object. For example, in some embodiments, the decryption key may be stored in a key vault external to the dual validation authentication system 105.

At operation 503, the dual validation authentication system, via the processor 202, memory 204, and/or the like, decrypts the encrypted validation object. The dual validation authentication system may decrypt the encrypted validation object using the decryption key. In some embodiments, the encrypted validation object is only decrypted in memory when addition of a secondary validation image (e.g., an endorsement) to the back of a check image is needed. In this regard, the dual validation authentication system 105, via the processor 202 and/or the like, may alter at least a portion of the requester validation image such that the secondary validation image may be imposed or otherwise added to the requester validation image.

Returning to the dual validation process of FIG. 3B, at operation 310, the dual validation authentication system 105, via the processor 202, memory 204, and/or the like, generates a first dual validation work object based at least on the dual validation data object, the secondary validation data, and the secondary validation image. In some embodiments, the first dual validation work object may comprise the altered requester validation image that includes the secondary validation image.

In some embodiments, once generated, the dual validation authentication system 105, via the processor 202, memory 204 and/or the like, may store the first dual validation work object, for example, in repository 106.

Once generated and optionally stored, the dual validation authentication system 105, via the processor 202, memory 204 and/or the like, may assign a first status to the first dual validation work object. For example, the first status may indicate that the dual validation data object has been received and/or the dual validation work object has been generated and stored but has not undergone any further processing yet.

In some embodiments, upon generating the dual validation work object, the dual validation authentication system 105, via the processor 202, communications circuitry 208, and/or the like, may provide a notification to the user indicating that their submitted check has been received. This notification may be provided in any number of ways, such as via a user interface, via Short Message Service (SMS) text message, and/or other communication means.

In some embodiments, once the dual validation work object has been assigned the first status, data associated with the dual validation work object may be transmitted an account management service 122. For example, the account management service may process the data associated with the dual validation work object in order to allocate funds to a clearing account associated with the dual validation authentication system 105. In this regard, funds may be allocated such that the mobile deposit of the dual validation data object will be successful.

In some embodiments, once the data associated with the dual validation work object has been transmitted to the account management service, the dual validation authentication system 105 may update the first status of the first dual validation work object by assigning a second status to the first dual validation work object. For example, the second status may indicate that data associated with the dual validation work object has been provided to the account management service and that the dual validation work object is in condition to be provided to an accounting conduit service for further processing.

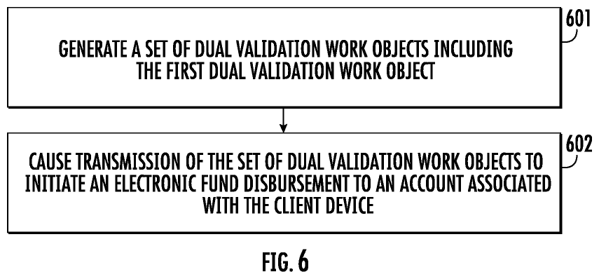

In some embodiments, dual validation work objects may be provided to an accounting conduit service in a batch format. Turning to FIG. 6, at operation 601, the dual validation authentication system 105, via the processor 202, memory 204, and/or the like, generates a set of dual validation work objects including the first dual validation work object. In some embodiments, the set of dual validation work objects may comprise all dual validation work objects that are currently stored in association with the second status (e.g., the status indicating the dual validation work object is in condition to be provided to an accounting conduit service).

At operation 602, the dual validation authentication system 105, via the processor 202, memory 204, communications circuitry 208, and/or the like, causes transmission of the set of dual validation work objects to initiate an electronic fund disbursement to an account associated with the client device. For example, in some embodiments, the set of dual validation work objects may be transmitted to an accounting conduit service, such that one or more accounting records associated with the dual validation authentication system 105 can be updated prior to transmittal of the dual validation work object to a financial institution 124 wherein the issuance of electronic funds associated with the dual validation work object may be executed.

### Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A dual validation authentication system comprising one or more computers and one or more storage devices storing instructions that are operable, when executed by the one or more computers, to cause the dual validation authentication system to:
receive a loss authentication data object from a client device, the loss authentication data object comprising loss authentication parameters including at least an identifier of a first entity;
compare the loss authentication parameters to remote dual validation authorization criteria;
in a circumstance where the loss authentication parameters are determined to satisfy the remote dual validation authorization criteria:
output a dual validation authorization approval instruction;
receive a dual validation data object from the client device, the dual validation data object comprising requester validation data and a requester validation image;
determine whether data extracted from the dual validation data object satisfies a predefined threshold;
in accordance with determining that the data extracted from the dual validation data object satisfies the predefined threshold:
access from a device that is remote from the client device, secondary validation data and a secondary validation image associated with a secondary entity associated with the dual validation data object;
generate a first dual validation work object comprising at least the requester validation image received from the client device, and the secondary validation image accessed from the device that is remote from the client device;
generate a set of dual validation work objects including the first dual validation work object; and
cause transmission of the set of dual validation work objects to initiate an electronic fund disbursement to an account associated with the client device.

2. The dual validation authentication system of claim 1, wherein the loss authentication parameters comprise one or more of a client identifier, a loan identifier, a loss date identifier, a loss amount identifier, and a loss cause identifier.

3. The dual validation authentication system of claim 2, wherein the instructions that are operable, when executed by the one or more computers, to cause the dual validation authentication system to compare the loss authentication parameters to the remote dual validation authorization criteria are further operable to cause the dual validation authentication system to:
determine whether the loss amount identifier exceeds a predefined loss amount threshold,
wherein the loss authentication parameters are determined to satisfy the remote dual validation authorization criteria in a circumstance where the loss amount identifier does not exceed the predefined loss amount threshold.

4. The dual validation authentication system of claim 1, wherein the instructions are further operable, when executed by the one or more computers, to cause the dual validation authentication system to:
initiate a remote dual validation client interface to be rendered at the client device, the remote dual validation client interface configured to capture at least the requester validation image; and
upon receiving the dual validation data object, extract textual data from the requester validation image of the dual validation data object.

5. The dual validation authentication system of claim 1, wherein the instructions are further operable, when executed by the one or more computers, to cause the dual validation authentication system to:
in accordance with determining that the data extracted from the dual validation data object fails to satisfy the predefined threshold:
cause transmission of a notification to the client device, the notification comprising instructions for resubmission of the dual validation data object.

6. The dual validation authentication system of claim 1, wherein the instructions that are operable, when executed by the one or more computers, to cause the dual validation authentication system to access the secondary validation data and the secondary validation image are further operable to cause the dual validation authentication system to:
access an encrypted validation object comprising the secondary validation data and the secondary validation image;
access a decryption key for the encrypted validation object; and
decrypt the encrypted validation object.

7. The dual validation authentication system of claim 1, wherein the instructions are further operable, when executed by the one or more computers, to cause the dual validation authentication system to:
in the circumstance where the loss authentication parameters are determined to satisfy the remote dual validation authorization criteria:
generate a tracking identifier for the loss authentication data object; and
initiate a loss tracking client interface to be rendered at the client device, the loss tracking client interface comprising an indication of the tracking identifier and configured to provide status updates associated with the loss authentication data object to a user of the client device.

8. The dual validation authentication system of claim 7, wherein the instructions are further operable, when executed by the one or more computers, to cause the dual validation authentication system to:
upon generating the first dual validation work object, update the loss tracking client interface to comprise a status update indicating an acceptance of the dual validation data object.

9. The dual validation authentication system of claim 1, wherein the instructions are further operable, when executed by the one or more computers, to cause the dual validation authentication system to:
upon generating the set of dual validation work objects including the first dual validation work object, store the set of dual validation work objects for a predetermined time period, wherein the set of dual validation work objects is caused to be transmitted upon expiration of the predetermined time period.

10. The dual validation authentication system of claim 1, wherein the data extracted from the dual validation data object comprises a payor identifier, one or more payee identifiers, one or more account identifiers, a dual validation data object amount identifier, a dual validation data object issue date identifier, and a dual validation data object identifier.

11. A method for providing dual validation authentication, the method comprising:
receiving a loss authentication data object from a client device, the loss authentication data object comprising loss authentication parameters including at least an identifier of a first entity;
comparing the loss authentication parameters to remote dual validation authorization criteria;
in a circumstance where the loss authentication parameters are determined to satisfy the remote dual validation authorization criteria:
outputting a dual validation authorization approval instruction;
receiving a dual validation data object from the client device, the dual validation data object comprising requester validation data and a requester validation image;
determining whether data extracted from the dual validation data object satisfies a predefined threshold;
in accordance with determining that the data extracted from the dual validation data object satisfies the predefined threshold:
accessing from a device that is remote from the client device, secondary validation data and a secondary validation image associated with a secondary entity associated with the dual validation data object;
generating a first dual validation work object comprising at least the requester validation image received from the client device, and the secondary validation image accessed from the device that is remote from the client device;
generating a set of dual validation work objects including the first dual validation work object; and
causing transmission of the set of dual validation work objects to initiate an electronic fund disbursement to an account associated with the client device.

12. The method of claim 11, wherein the loss authentication parameters comprise one or more of a client identifier, a loan identifier, a loss date identifier, a loss amount identifier, and a loss cause identifier.

13. The method of claim 12, wherein comparing the loss authentication parameters to the remote dual validation authorization criteria further comprises:
determining whether the loss amount identifier exceeds a predefined loss amount threshold,
wherein the loss authentication parameters are determined to satisfy the remote dual validation authorization criteria in a circumstance where the loss amount identifier does not exceed the predefined loss amount threshold.

14. The method of claim 11, further comprising:
initiating a remote dual validation client interface to be rendered at the client device, the remote dual validation client interface configured to capture at least the requester validation image; and
upon receiving the dual validation data object, extracting textual data from the requester validation image of the dual validation data object.

15. The method of claim 11, further comprising:
in accordance with determining that the data extracted from the dual validation data object fails to satisfy the predefined threshold:
causing transmission of a notification to the client device, the notification comprising instructions for resubmission of the dual validation data object.

16. The method of claim 11, wherein accessing the secondary validation data and the secondary validation image further comprises:
accessing an encrypted validation object comprising the secondary validation data and the secondary validation image;
accessing a decryption key for the encrypted validation object; and
decrypting the encrypted validation object.

17. The method of claim 11, further comprising:
in the circumstance where the loss authentication parameters are determined to satisfy the remote dual validation authorization criteria:
generating a tracking identifier for the loss authentication data object; and
initiating a loss tracking client interface to be rendered at the client device, the loss tracking client interface comprising an indication of the tracking identifier and configured to provide status updates associated with the loss authentication data object to a user of the client device.

18. The method of claim 17, further comprising:
upon generating the first dual validation work object, updating the loss tracking client interface to comprise a status update indicating an acceptance of the dual validation data object.

19. The method of claim 11, further comprising:
upon generating the set of dual validation work objects including the first dual validation work object, storing the set of dual validation work objects for a predetermined time period,
wherein the set of dual validation work objects is caused to be transmitted upon expiration of the predetermined time period.

20. The method of claim 11, wherein the data extracted from the dual validation data object comprises a payor identifier, one or more payee identifiers, one or more account identifiers, a dual validation data object amount identifier, a dual validation data object issue date identifier, and a dual validation data object identifier.

21. The dual validation authentication system of claim 1, wherein generating the first dual validation work object comprises altering at least a portion of the request validation image to include the secondary validation image.

22. The dual validation authentication system of claim 1, wherein the first entity and secondary entity are payees associated with the dual validation data object.

23. The method of claim 11, wherein generating the first dual validation work object comprises altering at least a portion of the request validation image to include the secondary validation image.

24. The method of claim 11, wherein the first entity and secondary entity are payees associated with the dual validation data object.
